(19) United States
(12) Patent Application Publication
(10) Pub. No.: US 2026/0176474 A1
(43) Pub. Date: Jun. 25, 2026

(54) COATING COMPOSITION FOR VEHICLE WITH IMPROVED VISCOSITY AND GAS BARRIER PROPERTIES

(71) Applicants: Hyundai Motor Company, Seoul (KR); Kia Corporation, Seoul (KR); IUCF-HYU (Industry-University Cooperation Foundation Hanyang University), Seoul (KR)

(72) Inventors: Jae Sik SEO, Hwaseong-si (KR); Chan Wook PARK, Hwaseong-si (KR); Young Ho EOM, Seoul (KR); Hyo Jeong KIM, Seoul (KR)

(21) Appl. No.: 19/198,680

(22) Filed: May 5, 2025

(30) Foreign Application Priority Data
Dec. 20, 2024 (KR) 10-2024-0192415

(51) Int. Cl. C09D 5/02; C08L 5/08; C08L 91/06; C09D 7/40; C09D 7/65; C09D 101/02; C09D 101/26; C09D 105/00; C09D 129/04

(52) U.S. Cl. CPC C09D 5/024; C09D 7/65; C09D 7/68; C09D 7/70; C09D 101/02; C09D 101/26; C09D 105/00; C09D 129/04; C08L 5/08; C08L 91/06; C08L 2207/53

(57) ABSTRACT

A coating composition for a vehicle includes (i) an aqueous dispersion containing chitosan nanoparticles dispersed in an aqueous solvent and (ii) a natural binder. The coating composition further includes a natural wax.

### CROSS-REFERENCE TO RELATED APPLICATION

This application claims priority to Korean Patent Application No. 10-2024-0192415, filed on Dec. 20, 2024, the disclosure of which is incorporated herein by reference in its entirety.

### TECHNICAL FIELD

The present disclosure relates to a coating composition for a vehicle with improved viscosity and gas barrier properties, which includes chitosan nanoparticles derived from biomass and a natural binder and is thus environmentally friendly and can exhibit excellent viscosity and gas barrier properties.

### BACKGROUND

Functional coating compositions that serve, for example, water-repellency, antifouling, and anti-fingerprint functions may be widely applied in various fields. For example, such a coating composition may be applied to the interior materials of a vehicle, such as the steering wheel, seats, dashboard, etc., or to the touchscreen of the instrument panel or center fascia.

### SUMMARY

In some examples, fluorine-based, silane-based, and urethane-based coating compositions can be used as functional coating compositions, and binders can be added to control viscosity and elasticity of the coating compositions to suit various applications. However, in some cases, binders pose environmental concerns due to the use of polymer materials derived from petroleum-based compounds.

The present disclosure addresses the issues described above by providing an environmentally friendly coating composition derived from biomass. In addition, the present disclosure provides a coating composition for a vehicle having excellent viscosity and gas barrier properties and a coating layer for a vehicle manufactured therefrom.

The objects of the present disclosure are not limited to the foregoing. The objects of the present disclosure will be able to be clearly understood through the following description and to be realized by the means described in the claims and combinations thereof.

An aspect of the present disclosure provides a coating composition for a vehicle, including an aqueous dispersion containing chitosan nanoparticles dispersed in an aqueous solvent and a natural binder.

In some implementations, the chitosan nanoparticles can have any one shape selected from a group consisting of a rod, fibril, filament, whisker, and combinations thereof. In some cases, other shapes can also be included.

In some examples, each of the chitosan nanoparticles can have a diameter of 10 nm to 100 nm and a length of 100 nm to 500 nm.

In some implementations, each of the chitosan nanoparticles can be represented by Chemical Formula below.

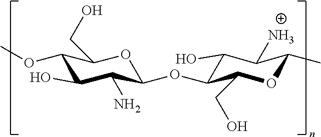

In some implementations, the natural binder can include a negatively charged binder. For example, the natural binder can include any one selected from a group consisting of gelatin, hydroxypropyl cellulose (HPC), hydroxypropyl methyl cellulose (HPMC), polyvinyl alcohol (PVA), sodium alginate (SA), xanthan gum, carboxymethyl cellulose (CMC), guar gum, and combinations thereof. In some cases, other binders can also be used.

In some implementations, a weight ratio of the chitosan nanoparticles to the natural binder can be from 1:0.1 to 1:3.

In some implementations, the coating composition can have a viscosity of 0.1 Pascal·second (Pa·S) to 40 Pa·S.

In some implementations, a concentration of the chitosan nanoparticles in the aqueous dispersion can be 0.1 weight/weight % (w/w %) to 5 w/w %.

In some implementations, the coating composition can further include a natural wax. For example, the natural wax can include any one selected from a group consisting of beeswax, soy wax, palm wax, rice bran wax, carnauba wax, candelilla wax, shellac wax, and combinations thereof. In some cases, other waxes can also be used.

In some implementations, a weight ratio of the chitosan nanoparticles to the natural wax can be 1:0.1 to 1:10.

In some examples, the coating composition can include a core-shell complex including a core including the natural wax and a shell. Chitosan nanoparticles can be formed around a surface of the core. As such, an average particle diameter (D50) of the core-shell complex can be 3.5 μm to 6 μm.

Another aspect of the present disclosure provides a coating layer for a vehicle, manufactured from the coating composition described above.

In some implementations, the coating layer can have a Young's modulus of 13.5 MPa to 27 MPa, tensile strength of 10.0 MPa to 37 MPa, an elongation of 0.5% to 6.5%, and toughness of 3.0 MJ/m³ to 145 MJ/m³.

Another aspect of the present disclosure provides an article for use with a vehicle. The article includes a coating layer. The composition of the coating layer can include chitosan nanoparticles and a natural binder.

In some implementations, the coating layer has: (i) a Young's modulus of 13.5 megapascal (MPa) to 27 MPa, (ii) tensile strength of 10.0 MPa to 37 MPa, (iii) an elongation of 0.5% to 6.5%, and (iv) toughness of 3.0 megajoules per cubic meter (MJ/m³) to 145 MJ/m³.

In some implementations, each of the chitosan nanoparticles has any one shape selected from a group consisting of a rod, fibril, filament, whisker, and combinations thereof. In some cases, other shapes can also be used.

In some examples, each of the chitosan nanoparticles can have a diameter of 10 nm to 100 nm and a length of 100 nm to 500 nm.

In some implementations, the natural binder can include a negatively charged binder.

In some implementations, a weight ratio of the chitosan nanoparticles to the natural binder is from 1:0.1 to 1:3.

### BRIEF DESCRIPTION OF THE DRAWINGS

FIG. 1 shows examples of natural binder types, categorized into Group A and Group B based on viscosity.

FIG. 2A shows a structure of an example of a coating composition prepared by adding only a natural wax to an aqueous solvent.

FIG. 2B shows a structure of an example of a coating composition prepared by adding chitosan nanoparticles, a natural binder, and a natural wax to an aqueous solvent.

FIG. 3 shows a photograph of a coating composition according to Comparative Example 1 applied onto a PET film.

FIG. 4 shows photographs of coating compositions according to Examples 1 to 8 and each coating composition applied onto a PET film.

FIG. 5 shows photographs of the coating compositions according to Comparative Example 1, Example 3, and Example 5 applied onto each of a PET film and glass.

FIG. 6A shows the surface charge of an example of chitosan nanoparticles.

FIG. 6B shows the surface charge of an example of a natural binder.

FIG. 7A shows results of evaluating the rheological properties of the coating compositions according to Examples 1 to 4.

FIG. 7B shows results of evaluating the rheological properties of the coating compositions according to Examples 5 to 8.

FIG. 8 shows the viscosity of the coating compositions according to Examples 1 to 8.

FIGS. 9(a)-9(h) show results of analyzing nonlinear viscoelastic behavior with an increase in shear stress of the coating compositions according to Examples 1 to 8.

FIGS. 10(a)-FIG. 10(h) show results of analyzing dynamic frequency sweep of coating compositions according to Examples 1 to 8.

FIG. 11 shows results of analyzing the surface state of a coating layer manufactured from the coating composition according to each of Examples 1 to 8 using a scanning electron microscope (SEM).

FIG. 12A shows the stress-strain curve of a coating layer manufactured from the coating composition according to each of Examples 2, 3, and 5 to 8.

FIG. 12B shows modulus and tensile strength of a coating layer manufactured from the coating composition according to each of Examples 2, 3, and 5 to 8.

FIG. 12C shows elongation at break of a coating layer manufactured from the coating composition according to each of Examples 2, 3, and 5 to 8.

FIG. 12D shows toughness of a coating layer manufactured from the coating composition according to each of Examples 2, 3, and 5 to 8.

FIG. 13A shows the phase change process of the solution in the coating compositions according to Example 9 and Comparative Example 2.

FIG. 13B shows the form of the emulsion in the coating compositions according to Example 9 and Comparative Example 2.

FIG. 13C shows calculated diameter of the emulsion in the coating compositions according to Example 9 and Comparative Example 2.

FIG. 14A shows photographs of bananas with no coating composition applied and bananas with coating compositions applied according to Comparative Example 1 and Example 9 observed over time.

FIG. 14B is a graph showing the weight loss over time of bananas with the coating compositions applied according to Comparative Example 1, Example 5, and Example 9.

### DETAILED DESCRIPTION

### Method of Manufacturing Chitosan Nanoparticles

Chitosan is a natural, eco-friendly material, which is widely used as a raw material for food, medicine, cosmetics, etc, and is biodegradable after use, and is a linear polysaccharide composed of D-glucosamine and N-acetylglucosamine.

Technology for obtaining chitin in powder form (hereinafter referred to as chitin powder) from natural materials containing chitin, such as crustacean shells, mushroom mycelia, and insect exoskeletons (removal of CaCO₃ by HCl treatment, removal of protein by NaOH treatment) is widely used, but chitin powder alone may not exhibit any functionality. This chitin can be modified into chitosan through a deacetylation process, and in order to exhibit functionalities such as surface antibacterial properties, superhydrophobic properties, and the like, a nano-fibrillation process of chitosan is required. However, manufacturing chitosan nanoparticles using currently available chemical technology may require about two weeks, so productivity of chitosan nanoparticles may be very low.

More specifically, prior known method of manufacturing chitosan nanoparticles includes 1) preparing a chitin solution by adding chitin powder to an aqueous hydrochloric acid solution and then hydrolyzing the chitin powder through a reflux process of the chitin solution, 2) centrifuging the chitin solution after hydrolysis, adding sodium hydroxide to adjust the pH to a level of 6.5 to 7.5, and then performing a dialysis process on the solution with the adjusted pH for about 7 days to obtain a nano-chitin solution containing chitin nanoparticles, 3) deacetylating the chitin nanoparticles by adding sodium hydroxide to the nano-chitin solution, and 4) centrifuging the nano-chitin solution after deacetylation, adding hydrochloric acid to adjust the pH to a level of 6.5 to 7.5, and then performing a dialysis process on the solution with the adjusted pH for about 7 days to obtain a nano-chitosan solution containing chitosan nanoparticles.

The prior known method of manufacturing chitosan nanoparticles in such a chemical manner has the problem of low productivity because the dialysis process takes a very long time.

A method of manufacturing chitosan nanoparticles according to the present disclosure is capable of rapidly synthesizing chitosan nanoparticles based on a physical grinding process, and can include preparing a chitin solution by adding chitin powder to an aqueous acid solution, hydrolyzing the chitin powder by performing mechanical milling on the chitin solution, adding a nano-chitin solution containing chitin nanoparticles to an aqueous solvent and performing neutralization and washing using a homogenizer, deacetylating the chitin nanoparticles by adding a base material to a nano-chitin aqueous dispersion containing the chitin nanoparticles and then performing mechanical milling, and adding a nano-chitosan solution containing chitosan nanoparticles to an aqueous solvent and performing neutralization and washing using a homogenizer.

Below is a detailed description of individual steps.

First, a chitin solution is prepared by adding chitin powder to an aqueous acid solution, for example, an aqueous hydrochloric acid solution. Here, the pH of the chitin solution is about 1 to 2, and the concentration of chitin in the chitin solution can be about 3 to 4 wt %.

Next, the prepared chitin solution is placed in a mechanical milling device, such as a ball mill for grinding the contents with zirconia balls, followed by ball milling at a rotation speed of about 100 to 500 rpm for 0.5 to 4 hours. During this process, chitin powder is ground and hydrolyzed and thus becomes nanosized and converted into chitin nanoparticles.

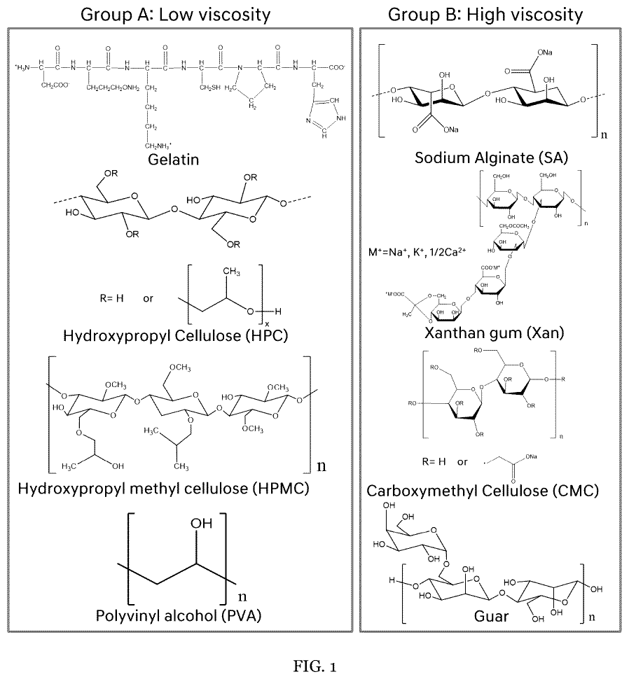

Thereafter, the nano-chitin solution containing the chitin nanoparticles is removed from the ball mill and added to an aqueous solvent (e.g., Di-water) with a homogenizer installed, as shown in FIG. 1, using a syringe or the like, while adjusting the addition speed to 1 to 300 ml/h. Here, the rotation speed of the homogenizer is not particularly limited and is preferably about 1,000 to 6,000 rpm. In this process, the acidic nano-chitin solution is neutralized and phase separated into a nano-chitin aqueous dispersion containing chitin nanoparticles and an aqueous solvent and the remainder.

The pH of the nano-chitin aqueous dispersion is about 6.5 to 7.5, and the concentration of the chitin nanoparticles in the nano-chitin aqueous dispersion is about 2.4 to 3.3 wt %.

Next, a base material, for example, sodium hydroxide, can be added to the nano-chitin aqueous dispersion and then placed in a mechanical milling device to perform mechanical milling. As such, the concentration of sodium hydroxide that is added can be about 30 wt % of the nano-chitin aqueous dispersion. During this process, chitin nanoparticles are deacetylated and converted into chitosan nanoparticles. Also, the pH of the nano-chitosan solution containing chitosan nanoparticles immediately after deacetylation can be about 11 to 13, and the concentration of chitosan nanoparticles can be about 2.4 to 3.3 wt %. For reference, the conditions for mechanical milling can be the same as those described above.

Thereafter, the nano-chitosan solution is removed from the mechanical milling device and added to an aqueous solvent (e.g., Di-water) with a homogenizer installed. In this process, the nano-chitosan solution that is alkaline is neutralized and phase separated into an aqueous dispersion containing chitosan nanoparticles and an aqueous solvent and the remainder. In some examples, “aqueous dispersion” can be understood to include chitosan nanoparticles and an aqueous solvent.

The pH of the aqueous dispersion after the washing process using the homogenizer can be about 6.5 to 7.5, and the concentration of chitosan nanoparticles in the aqueous dispersion can be about 1 to 1.5 wt %. For reference, the method of adding the nano-chitosan solution, conditions, and washing conditions using a homogenizer can be the same as those described above.

The method of manufacturing chitosan nanoparticles according to the present disclosure can include hydrolyzing chitin powder or deacetylating chitin nanoparticles using a mechanical milling process, followed by a neutralization and washing process using a homogenizer, thereby omitting a pH control process and a dialysis process, unlike conventional chemical synthesis methods. Accordingly, a period of time required for each of the hydrolysis step, the neutralization and washing step for the nano-chitin solution, the deacetylation step, and the neutralization and washing step for the nano-chitosan solution can be reduced to less than 12 hours.

More specifically, the hydrolysis step and the deacetylation step can each be performed for 0.5 to 4 hours, and the neutralization and washing step for the nano-chitin solution and the neutralization and washing step for the nano-chitosan solution can each be performed for 3 to 5 hours. Accordingly, a total period of time required for the process of manufacturing chitosan nanoparticles from chitin powder can be shortened to less than 24 hours.

Furthermore, the degree of deacetylation, which is a measure of conversion from chitin to chitosan, can be about 20% to 60%. This numerical value is higher than 20% to 50%, which is the degree of deacetylation known in conventional chemical synthesis methods.

Consequently, according to the manufacturing method of the present disclosure, chitosan nanoparticles can be synthesized with higher yield in a shorter time.

### Coating Composition for Vehicle

A coating composition for a vehicle according to the present disclosure can include an aqueous dispersion containing chitosan nanoparticles dispersed in an aqueous solvent and a natural binder. Here, the method of preparing the chitosan nanoparticles is not particularly limited. Chitosan nanoparticles can be directly manufactured or those known can be purchased, but preferably, chitosan nanoparticles manufactured according to the “Method of manufacturing chitosan nanoparticles” above are used.

In some implementations, the coating composition according to the present disclosure can be used toward, or applied to, an article for use with a vehicle. The term “article for a vehicle” can refer to any physical object, component, or substrate that is intended to be applied to, integrated with, or used in conjunction with a vehicle. This can include exterior or interior vehicle surfaces, body panels, trim pieces, films, coatings, or any intermediate materials that are coated on a vehicle. The article can be part of the vehicle itself or a separate structure intended for attachment or integration to the vehicle. Further, the term “article” can also include its conventionally understood meaning in the field.

The coating composition according to the present disclosure can exhibit functional properties such as water repellency and antibacterial properties by use of chitosan nanoparticles obtained by nano-forming chitosan. Specifically, the chitosan nanoparticles can be represented by the following chemical formula.

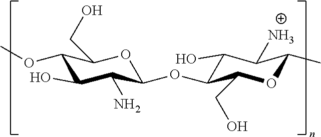

The chitosan nanoparticles represented by the chemical formula above can exhibit antibacterial and water-repellent properties by containing an amine group (—NH₃⁺) in some of the repeat unit.

In some implementations, the chitosan nanoparticles can have any one shape (hereinafter referred to as fibril structure) selected from the group consisting of a rod, fibril, filament, whisker, and combinations thereof. Also, the chitosan nanoparticles having this shape can have a diameter of 10 nm to 100 nm, preferably 10 nm to 30 nm, and a length of 100 nm to 500 nm. In some implementations, other shapes can also be used.

When the coating composition contains only chitosan nanoparticles, it can be difficult to obtain phase stability due to strong agglomeration of the nanomaterial, and there can be limitations in processability due to low viscosity. The coating composition according to the present disclosure can include a natural binder capable of controlling viscoelasticity-based processability of the coating composition, in addition to the chitosan nanoparticles, thereby obtaining processability suitable for various applications such as spray coating, film, 3D printing, and the like, and exhibiting functionality such as gas barrier properties, etc.

In some implementations, the natural binder can include a negatively charged binder. The coating composition according to the present disclosure is able to enhance interaction with chitosan nanoparticles having a positive charge (—NH₃⁺) by including a negatively charged natural binder. Thus, the coating composition according to the present disclosure can have excellent spreadability and can be uniformly applied onto a substrate.

Here, the natural binder can be a binder obtained directly from biomass rather than derived from petroleum or crude oil, or a binder obtained indirectly from biomass by certain treatment.

FIG. 1 shows the types of natural binder used in the present disclosure divided into low-viscosity group (A) and high-viscosity group (B) depending on viscosity.

The natural binder used in the present disclosure is not particularly limited so long as it is a biomass-derived material that is able to increase viscosity and gas barrier properties of the coating composition, and can include, for example, any one selected from the group consisting of gelatin, hydroxypropyl cellulose (HPC), hydroxypropyl methyl cellulose (HPMC), and polyvinyl alcohol (PVA), which have relatively low viscosity; sodium alginate (SA), xanthan gum, carboxymethyl cellulose (CMC), and guar gum, which have relatively high viscosity; and combinations thereof, as shown in FIG. 1. In some implementations, other binders can also be used.

When a low-viscosity natural binder is used as a natural binder applied to the coating composition, it can be advantageous upon forming a coating layer by a process such as spray coating, etc., and when a high-viscosity natural binder is used, it can be advantageous upon forming a coating layer by a process such as a casting process, etc.

In some implementations, the weight ratio of the chitosan nanoparticles to the natural binder included in the coating composition can be 1:0.1 to 1:3. Preferably, the weight ratio of the chitosan nanoparticles to the natural binder is about 1:1.

If the coating composition includes the natural binder in a weight ratio of less than 1:0.1 relative to the chitosan nanoparticles, the viscosity increasing effect and the gas barrier effect can be minimal, whereas if the coating composition includes the natural binder in a weight ratio of greater than 1:3 relative to the chitosan nanoparticles, the viscosity of the coating composition can excessively increase, deteriorating processability.

In some implementations, the viscosity of the coating composition can be 0.1 Pa·S to 40 Pa·S. When the coating composition includes only chitosan nanoparticles without a natural binder, viscosity thereof can be about 0.02 Pa·S. The coating composition according to the present disclosure can have a viscosity about 5 to 2,000 times higher than when it includes only chitosan nanoparticles because it includes the natural binder.

For reference, the viscosity of the coating composition can be measured at room temperature (about 25° C.) using a rotational rheometer under conditions of a strain of 1% and an angular frequency (angular velocity) of 0.05 to 500 rad/s.

In some implementations, the concentration of the chitosan nanoparticles in the aqueous dispersion can be 0.1 w/w % to 5 w/w %. If the concentration of the chitosan nanoparticles is less than 0.1 w/w %, the content of the chitosan nanoparticles in the coating composition is too small, making it difficult to exhibit functions such as water repellency, antibacterial properties, and the like due to the chitosan nanoparticles. On the other hand, if the concentration of the chitosan nanoparticles exceeds 5 w/w %, the chitosan nanoparticles can agglomerate with each other, making it difficult to obtain phase stability.

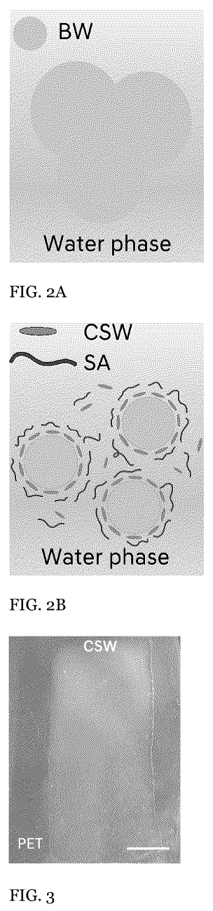

FIG. 2A shows the structure of a coating composition prepared by adding only a natural wax to an aqueous solvent, and FIG. 2B shows the structure of a coating composition prepared by adding chitosan nanoparticles, a natural binder, and a natural wax to an aqueous solvent. Referring to FIG. 2A and FIG. 2B, the coating composition for a vehicle according to another implementation of the present disclosure can further include a natural wax.

As shown in FIG. 2A, when only a natural wax is added to the aqueous solvent, the hydrophobic natural wax and the hydrophilic aqueous solvent do not form an emulsion, so natural waxes agglomerate with each other. On the other hand, when both the natural wax and the chitosan nanoparticles are added to the aqueous solvent as in the coating composition according to the present disclosure, the chitosan nanoparticles act as a surfactant between the aqueous solvent and the natural wax, thereby forming a Pickering emulsion even without a separate surfactant. Here, a Pickering emulsion can be understood as an emulsion stabilized by adsorption of solid particles at the interface between two phases of oil-aqueous solution.

More specifically, when the hydrophobic natural wax and the chitosan nanoparticles are added to an excess of aqueous solvent, the chitosan nanoparticles are adsorbed at the interface between the hydrophobic natural wax and the hydrophilic aqueous solvent to form a Pickering emulsion. Thus, the coating composition according to the present disclosure can include a core-shell complex including a core including the natural wax and a shell in which the chitosan nanoparticles are formed around the surface of the core, as shown in FIG. 2B.

Since the natural wax and the chitosan nanoparticles are able to form a core-shell complex in the aqueous solvent, the particles can be maintained in a dispersed phase without agglomerating with each other. In addition, the phase stabilization effect of the coating composition due to the viscosity increasing effect of the natural binder in the coating composition can also contribute to improving the dispersibility of the core-shell complex. Accordingly, the particle size can become smaller than when only the natural wax is present in the aqueous solvent. For example, the average particle diameter (D50) of the core-shell complex can be 3.5 μm to 6 μm.

In addition, since the coating composition including the core-shell complex does not easily solidify at room temperature, it can be easily applied onto a substrate by various processes such as spraying, doctor blade coating, dip coating, spin coating, etc. to form a coating layer.

In some implementations, the natural wax can include any one selected from the group consisting of beeswax, soy wax, palm wax, rice bran wax, carnauba wax, candelilla wax, shellac wax, and combinations thereof. In some implementations, other waxes can also be used.

Here, the natural wax can be a wax obtained directly from biomass rather than derived from petroleum or crude oil, or a wax obtained indirectly from biomass by certain treatment.

Also, the weight ratio of the chitosan nanoparticles to the natural wax can be 1:0.1 to 1:10. Preferably, the weight ratio of the chitosan nanoparticles to the natural wax is about 1:0.5.

If the coating composition includes the natural wax in a weight ratio of less than 1:0.1 relative to the chitosan nanoparticles, water repellency and water repellency persistence can decrease, and it can be difficult to apply the coating composition onto a substrate by spraying, dip coating, doctor blade coating, spin coating, etc. due to the low viscosity of the coating composition. In contrast, if the coating composition includes the natural wax in a weight ratio of greater than 1:10 relative to the chitosan nanoparticles, it can have low heat resistance, can cause peeling due to low affinity with a substrate, and can reduce mechanical properties, deteriorating coating durability.

Another aspect of the present disclosure provides a coating layer for a vehicle manufactured from the coating composition.

Specifically, the coating composition is applied onto a substrate (e.g., PET film, glass, leather, etc.) that requires properties such as water repellency, antibacterial properties, and gas barrier properties, followed by a process such as drying or annealing to remove the aqueous solvent, thereby forming a coating layer including chitosan nanoparticles, a natural binder, and optionally a natural wax. Here, the process of applying the coating composition onto the substrate is not particularly limited, and various processes such as spray coating, dip coating, spin coating, gravure coating, slot die coating, casting, 3D printing, and the like can be performed.

The coating layer for a vehicle manufactured from the coating composition according to the present disclosure can exhibit excellent mechanical properties, and can satisfy, for example, a Young's modulus of 13.5 MPa to 27 MPa, tensile strength of 10.0 MPa to 37 MPa, an elongation of 0.5% to 6.5%, and toughness of 3.0 MJ/m³ to 145 MJ/m³.

The coating composition according to the present disclosure can have excellent spreadability and processability, and can also have functional properties such as water repellency, antibacterial properties, and the like. Moreover, a coating layer manufactured from the coating composition has excellent gas barrier properties.

The coating composition according to the present disclosure can include an aqueous solvent, chitosan nanoparticles derived from biomass, a natural binder, and optionally a natural wax, and can be very environmentally friendly because chemicals such as surfactants are not used. In addition, high interfacial adhesion can be exhibited due to a bridging effect between the chitosan nanoparticles and the substrate. In addition, when the coating composition includes the natural wax, a core-shell complex is provided therein, and thus, the coating composition can be stable even at high temperatures of 100° C. or more. Furthermore, since the coating composition has excellent mechanical properties, it can be widely applied to substrates having various shapes, and coating durability can be excellent.

Below is a description of a method of preparing a coating composition for a vehicle according to the present disclosure.

### Method of Preparing Coating Composition for Vehicle

A method of preparing a coating composition for a vehicle according to the present disclosure can include obtaining an aqueous dispersion by mixing an aqueous solvent and chitosan nanoparticles, and preparing a coating composition by adding a natural binder to the aqueous dispersion. For reference, individual components used in the method of preparing the coating composition for a vehicle can be substantially the same as those described in the “Coating composition for vehicle.”

Specifically, chitosan nanoparticles can be added to an aqueous solvent and then dispersed using a process such as sonication to obtain an aqueous dispersion. As such, the concentration of the chitosan nanoparticles in the aqueous dispersion is not particularly limited and can be 0.1 w/w % to 5 w/w %.

Thereafter, the aqueous dispersion can be heated to a temperature of 50° C. to 100° C. or room temperature depending on the type of natural binder and then the natural binder can be added to prepare a coating composition. In addition, after adding the natural binder to the aqueous dispersion, a stirring process such as magnetic stirring can be performed.

In some implementations, cooling the coating composition can be performed when adding the natural binder after heating the aqueous dispersion to a temperature of 50° C. to 100° C. For example, the coating composition can be cooled in a low-temperature ice bath or the like.

In addition, the coating composition according to the present disclosure can be prepared by adding the natural binder and the natural wax to the aqueous dispersion. In this process, the chitosan nanoparticles can be adsorbed at the interface between the hydrophobic natural wax and the hydrophilic aqueous solvent, forming a Pickering emulsion. The coating composition can include a core-shell complex including a core including the natural wax and a shell in which the chitosan nanoparticles are formed around the surface of the core. Also, the natural binder can be located adjacent to the shell.

In some implementations, the method of preparing the coating composition according to the present disclosure can further include annealing the coating composition. The annealing step can be performed after applying the coating composition onto a substrate. Through annealing of the coating composition, the crystal structure of the natural wax of the core-shell complex and the fibril structure of the chitosan nanoparticles can be strengthened, and the morphology of the coating layer formed after annealing can exhibit a bead shape.

Also, the annealing process can be performed at a temperature higher than or equal to the melting point (Tm) of the natural wax. In general, when a coating composition including only a natural wax without chitosan nanoparticles is annealed at a temperature higher than or equal to the melting point of the natural wax, water repellency can decrease because the natural wax particles melt and the bead-shaped morphology may not be maintained.

Since the core-shell complex of the coating composition according to the present disclosure can include a core including the natural wax and a shell in which the chitosan nanoparticles are formed around the surface of the core, even if the natural wax melts due to annealing at a temperature higher than or equal to the melting point of the natural wax, the shell can be maintained by the chitosan nanoparticles. Accordingly, the coating composition or the coating layer manufactured from the coating composition is able to maintain a bead-shaped morphology and can have improved water repellency compared to before annealing.

Meanwhile, the annealing time is not particularly limited so long as it is able to strengthen the crystal structure of the natural wax of the core-shell complex and the fibril structure of the chitosan nanoparticles and to maintain the bead-shaped morphology, and annealing can be performed for, for example, 1 hour to 10 hours, 2 hours to 6 hours, preferably about 4 hours.

A better understanding of the present disclosure can be obtained through the following examples and comparative examples. However, these examples are not to be construed as limiting the technical spirit of the present disclosure.

### Preparation Example—Chitosan Nanoparticles

A 3.8 wt % chitin solution was prepared by adding 10 g of chitin powder to 250 ml of an aqueous 3 M hydrochloric acid solution. Thereafter, the chitin solution was placed in a ball mill and mixed at a rotation speed of 350 rpm for 5 hours, preparing a nano-chitin solution. As such, the balls placed in the ball mill are zirconia balls having a diameter of 8 mm.

Then, the nano-chitin solution was placed in a beaker containing DI-water using a syringe at a rate of 100 ml/h, followed by a neutralization and washing process using a homogenizer at 6,000 rpm for 3 hours. After 3 hours, the homogenizer was stopped, the upper layer of the solution in the beaker where phase separation occurred was removed, and the lower layer was separated.

Thereafter, sodium hydroxide was added at a level of about 30 wt % to the lower layer and placed in a ball mill, followed by a mechanical milling process at 350 rpm for 5 hours, deacetylating chitin nanoparticles.

Thereafter, the nano-chitosan solution containing the chitosan nanoparticles was placed in a beaker containing DI-water using a syringe at a rate of 100 ml/h, followed by a neutralization and washing process using a homogenizer at 6,000 rpm for 3 hours. After 3 hours, the homogenizer was stopped, the upper layer of the solution in the beaker where phase separation occurred was removed, and the lower layer was separated, obtaining an aqueous dispersion with chitosan nanoparticles dispersed in an aqueous solvent.

Thereafter, the aqueous dispersion was dried, thereby manufacturing chitosan nanoparticles.

### Example 1—CSW/Gelatin

A 1.5 w/w % CSW aqueous dispersion was prepared by adding 0.09 g of whisker-shaped chitosan nanoparticles (CSW) to 5.91 g of water. After the CSW aqueous dispersion was dispersed by sonication, 0.09 g of gelatin was added so that the weight ratio of the chitosan nanoparticles to gelatin was 1:1, and the mixture was stirred by magnetic stirring at about 50° C. for 2 hours, thereby preparing a coating composition according to Example 1.

### Example 2—CSW/HPMC

A coating composition according to Example 2 was prepared in the same manner as in Example 1, with the exception that hydroxypropyl methyl cellulose (HPMC) was added instead of gelatin as the natural binder in the CSW aqueous dispersion and stirring was performed at room temperature (25° C.) for 1 hour.

### Example 3—CSW/HPC

A coating composition according to Example 3 was prepared in the same manner as in Example 1, with the exception that hydroxypropyl cellulose (HPC) was added instead of gelatin as the natural binder in the CSW aqueous dispersion and stirring was performed at room temperature (25° C.) for 1 hour.

### Example 4—CSW/PVA

A coating composition according to Example 4 was prepared in the same manner as in Example 1, with the exception that polyvinyl alcohol (PVA) was added instead of gelatin as the natural binder in the CSW aqueous dispersion and stirring was performed at about 90° C. for 2 hours.

### Example 5—CSW/SA

A coating composition according to Example 5 was prepared in the same manner as in Example 1, with the exception that sodium alginate (SA) was added instead of gelatin as the natural binder in the CSW aqueous dispersion and stirring was performed at about 65° C. for 3 hours.

### Example 6—CSW/CMC

A coating composition according to Example 6 was prepared in the same manner as in Example 1, with the exception that carboxymethyl cellulose (CMC) was added instead of gelatin as the natural binder in the CSW aqueous dispersion and stirring was performed at room temperature (25° C.) for 3 hours.

### Example 7—CSW/Xan

A coating composition according to Example 7 was prepared in the same manner as in Example 1, with the exception that xanthan gum was added instead of gelatin as the natural binder in the CSW aqueous dispersion and stirring was performed at room temperature (25° C.) for 5 hours.

### Example 8—CSW/Guar

A coating composition according to Example 8 was prepared in the same manner as in Example 1, with the exception that guar gum was used instead of gelatin as the natural binder in the CSW aqueous dispersion and stirring was performed at room temperature (25° C.) for 5 hours.

### Example 9—CSW/SA/BW

A 1.5 w/w % CSW aqueous dispersion was prepared by adding 0.09 g of whisker-shaped chitosan nanoparticles (CSW) to 5.91 g of water. After the CSW aqueous dispersion was dispersed by sonication, 0.09 g of sodium alginate (SA) and 0.045 g of beeswax (BW) as a natural wax were added to prepare a mixed solution. Briefly, the mixed solution was prepared so that the weight ratio of CSW to BW therein was 1:0.5.

Thereafter, a coating composition according to Example 9 was prepared by mixing at about 90° C. and 6,000 rpm for 10 minutes using a homogenizer and then cooling in an ice bath for 10 minutes.

### Comparative Example 1—CSW

A 1.5 w/w % CSW aqueous dispersion was prepared by adding 0.09 g of whisker-shaped chitosan nanoparticles (CSW) to 5.91 g of water. The CSW aqueous dispersion was dispersed by sonication and then prepared as a coating composition according to Comparative Example 1.

### Comparative Example 2—BW

A coating composition according to Comparative Example 2 was prepared by adding 0.045 g of beeswax (BW) to 5.91 g of water and then dispersing the mixture using sonication.

### Test Example 1

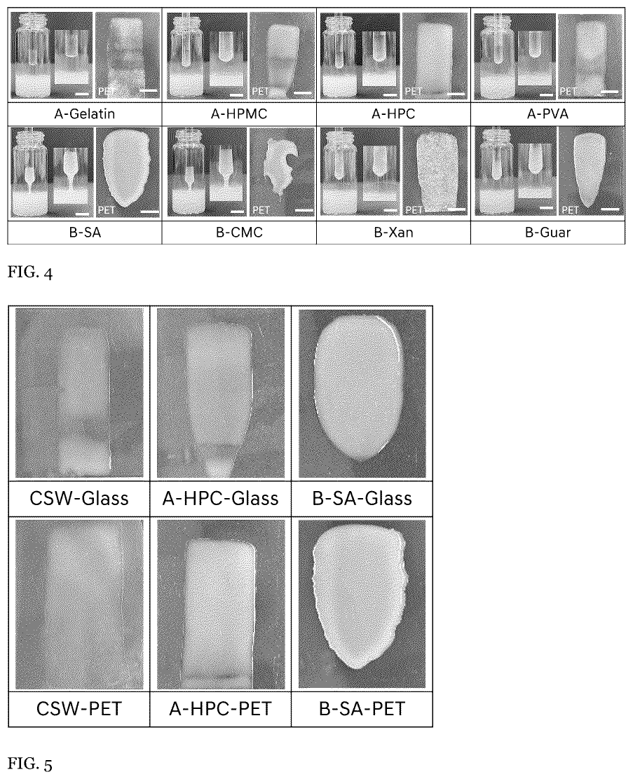

To determine spreadability of the coating composition, the coating composition according to each of Comparative Example 1 and Examples 1 to 8 was cast on a PET substrate using a bar coater. FIG. 3 shows a photograph of the coating composition according to Comparative Example 1 applied onto a PET film, and FIG. 4 shows photographs of glass rods dipped in and then taken out of the coating compositions according to Examples 1 to 8 and each coating composition applied onto a PET film.

Referring to FIGS. 3 and 4, it was confirmed that the coating composition according to Comparative Example 1, including only the CSW aqueous dispersion without a natural binder, was difficult to apply uniformly. In addition, coating with the coating compositions according to Examples 1 to 8 at a uniform thickness was confirmed to be possible, and in particular, Example 5 (B-SA) exhibited the best spreadability.

### Test Example 2

Each of the coating composition according to Example 3 including HPC, a low-viscosity binder (Group A) with a relatively weak viscosity-increasing effect and the coating composition according to Example 5 including SA, a high-viscosity binder (Group B) with a relatively strong viscosity-increasing effect, as shown in FIG. 4, was applied onto a PET film and glass, and then photographed and shown in FIG. 5. In addition, the same experiment was conducted on the coating composition according to Comparative Example 1, and the results thereof are shown in FIG. 5.

Referring to FIG. 5, both the coating composition according to Example 3 and the coating composition according to Example 5 exhibited coating performance at a uniform thickness on various substrates, compared to Comparative Example 1 including only the CSW aqueous dispersion without a natural binder.

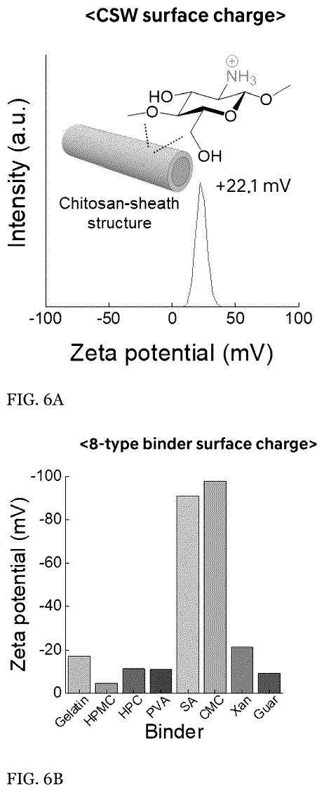

The reason why the coating composition according to Example exhibits better spreadability and coating performance than Comparative Example 1 including only the CSW aqueous dispersion without a natural binder is deemed to be because the natural binder having a negative charge interacts with the chitosan nanoparticles having a positive charge (—NH₃⁺), as can be seen in FIG. 6A showing the surface charge of chitosan nanoparticles and FIG. 6B showing the surface charge of the natural binder used in the present disclosure.

### Test Example 3

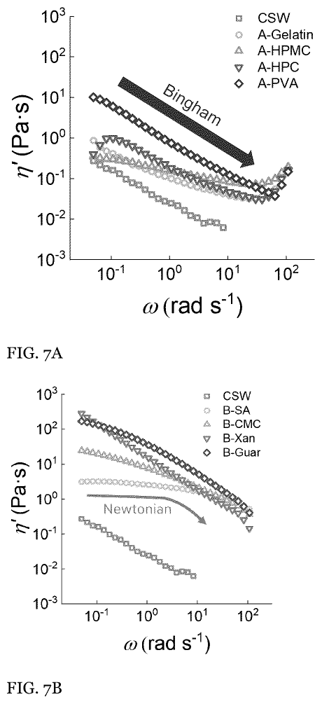

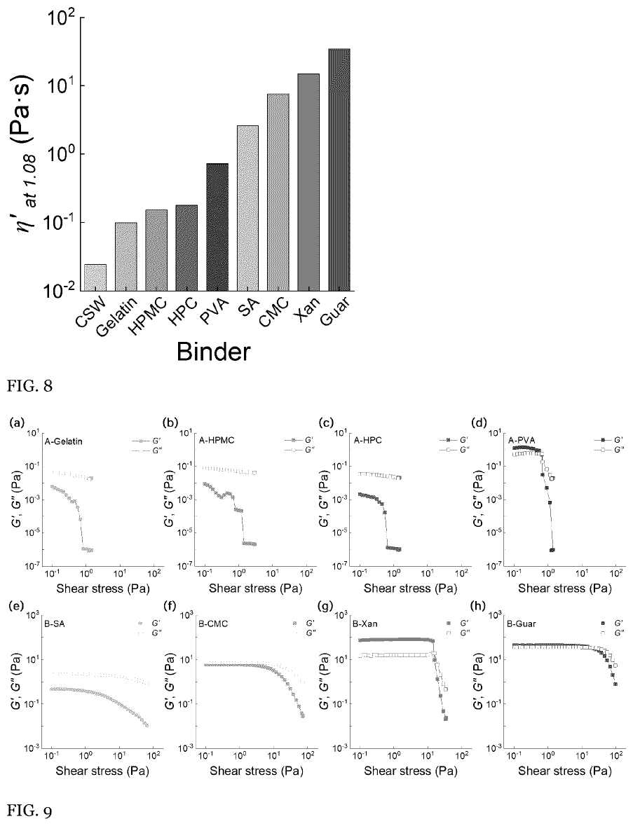

The rheological properties (viscoelasticity) of the coating compositions according to Comparative Example 1 and Examples 1 to 8 were measured under conditions of a strain of 1% and an angular frequency of 0.05 to 500 rad/s using a rotational rheometer. FIG. 7A shows results of evaluating the rheological properties of the coating compositions according to Examples 1 to 4, and FIG. 7B shows results of evaluating the rheological properties of the coating compositions according to Examples 5 to 8. Based on the measurement results, the viscosity of each coating composition at an angular frequency of 1.08 rad/s is shown in FIG. 8 and Table 1 below.

Referring to FIG. 7A, the coating compositions according to Examples 1 to 4 using low-viscosity binders exhibited Non-Newtonian behavior and Bingham behavior. Since Bingham behavior is mainly observed in a heterogeneous colloidal phase, Examples 1 to 4 using low-viscosity binders are found to be in an unstable suspension state, like Comparative Example 1.

In addition, referring to FIG. 7B, the coating compositions according to Examples 5 to 8 using high-viscosity binders exhibited partial Newtonian behavior and Bingham behavior. The coating compositions according to Examples 5 to 8 using high-viscosity binders, particularly Example 5 using sodium alginate, exhibited clear Newtonian behavior at a low angular frequency, thus maintaining a uniform and stable phase.

TABLE 1

| Coating composition | Viscosity (Pa · s) | Increase factor (times) |
|---|---|---|
| CSW dispersion | 0.02 | — |
| CSW/Gelatin | 0.10 | 5 |
| CSW/HPMC | 0.15 | 7.5 |
| CSW/HPC | 0.18 | 9 |
| CSW/PVA | 0.73 | 36.5 |
| CSW/SA | 2.58 | 129 |
| CSW/CMC | 7.52 | 376 |
| CSW/Xan | 14.85 | 742.5 |
| CSW/Guar | 34.78 | 1739 |

In addition, referring to the results in FIGS. 7 and 8 and Table 1, all of the coating compositions according to Examples 1 to 4 using low-viscosity binders and Examples 5 to 8 using high-viscosity binders exhibited increased viscosity values compared to the coating composition according to Comparative Example 1. In particular, the coating compositions according to Examples 5, 6, 7, and 8 exhibited viscosities increased by about 129 times, 376 times, 743 times, and 1,740 times, respectively, compared to Comparative Example 1.

### Test Example 4

Following Test Example 3, the nonlinear viscoelastic behavior with an increase in shear stress was measured to analyze phase stability and coating performance of the coating compositions according to Examples 1 to 8 under high shear stress conditions using the rotational rheometer, and the results thereof are shown in FIGS. 9(a) to 9(h).

Referring to FIG. 9, in Examples 1 to 4 using low-viscosity binders, the elastic (G′) and viscous (G″) moduli rapidly decreased at points near and below about 1 Pa, indicating that the phase is unstable under high shear stress and spreadability is relatively low. In addition, in Examples 5 to 8 using high-viscosity binders, both moduli were stably maintained up to high shear stress, indicating that excellent spreadability is exhibited even under high shear stress.

In particular, the coating compositions containing SA (Example 5) or CMC (Example 6) binders, which show a gradual modulus decrease, are expected to exhibit better spreadability than the coating compositions containing Xan (Example 7) or Guar (Example 8) binders, which show a rapid modulus decrease at a certain point.

This expectation is also consistent with the results confirmed in FIG. 4 of Test Example 1.

### Test Example 5

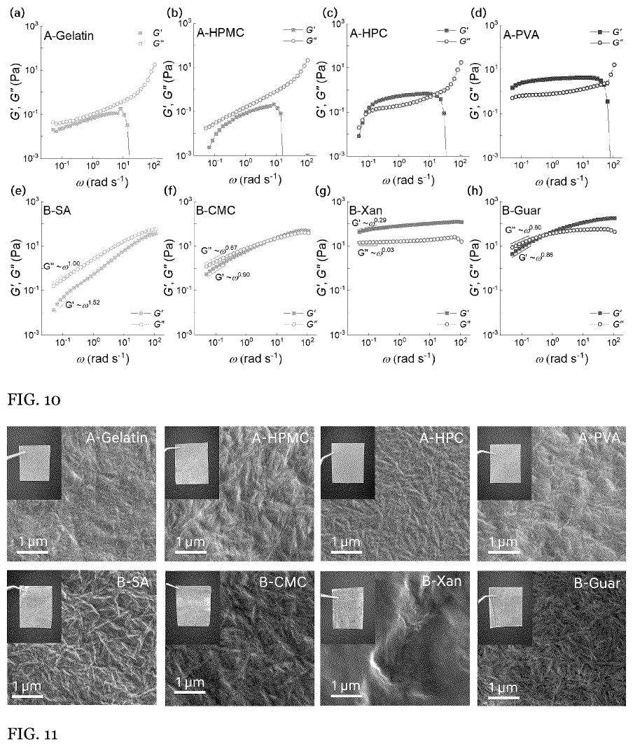

Following Test Examples 3 and 4, dynamic frequency sweep of the coating compositions according to Examples 1 to 8 was analyzed using the rotational rheometer, and the results thereof are shown in FIGS. 10(a) to 10(h).

In G′ and G″ curves for the dynamic frequency sweep of FIG. 10, Examples 1 to 4 using low-viscosity binders showed a sharp decrease in G′ at a high shear rate, which means that the solution is unstable at a high shear rate. Also, in Examples 5 to 8 using high-viscosity binders, viscoelastic properties were clearly maintained even at a high shear rate, and in particular, Example 5 using sodium alginate (SA) had a relatively low modulus at a low shear rate but exhibited an increased modulus at a high shear rate, confirming that viscoelastic properties were well maintained.

Also, in Example 7 using xanthan gum (Xan), a modulus plateau appears, which is a typical gel characteristic, and thus, the coating composition according to Example 7 is expected to be suitable for use in processes requiring high-temperature 3D printing or gelation.

### Test Example 6

A coating layer having a thickness of about 20 μm to 30 μm was manufactured by casting the coating composition according to each of Examples 1 to 8 on a substrate (glass plate). After drying the coating layer at a temperature of 60° C. for 1 hour, the surface state of the coating layer was analyzed using a scanning electron microscope (SEM). The results thereof are shown in FIG. 11.

Referring to FIG. 11, in the coating layers manufactured from the coating compositions according to Examples 1 to 6 and Example 8, chitosan nanoparticles were evenly distributed and the surfaces thereof exhibited a needle-shaped fibril structure indicative of excellent water repellency. Also, the coating layer manufactured from the coating composition according to Example 7 (Xan) was confirmed to be in an agglomerated form within the system.

### Test Example 7

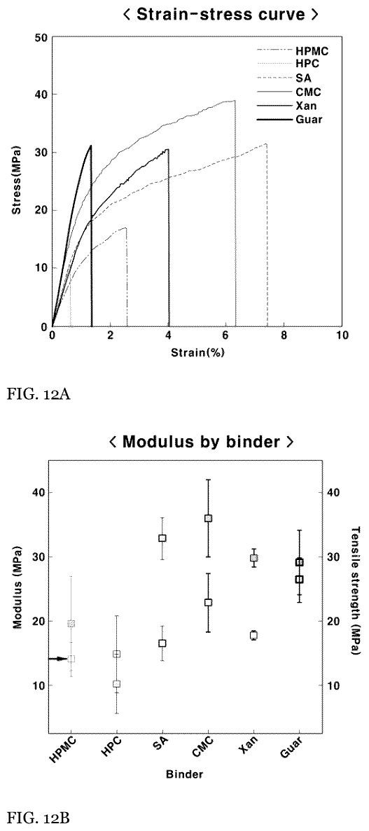

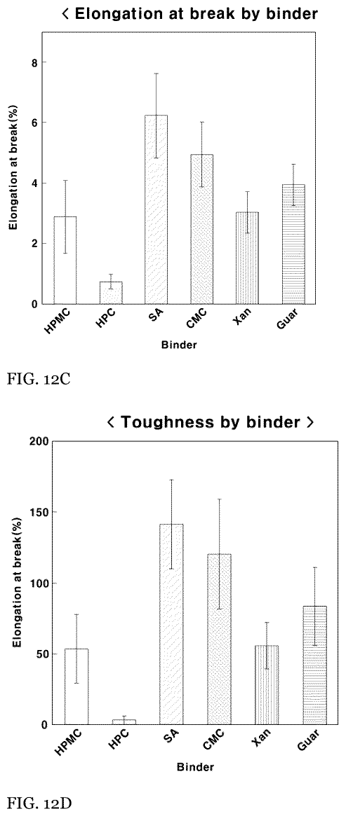

After separating the coating layer manufactured in Test Example 6 from the substrate, the mechanical properties thereof were measured. However, the coating layer manufactured from the coating composition according to each of Examples 1 and 4 was excluded from the evaluation because it was difficult to peel off of the glass plate. FIG. 12A shows a stress-strain curve of the coating layer manufactured from the coating composition according to each of Examples 2, 3, and 5 to 8, FIG. 12B shows modulus and tensile strength thereof, FIG. 12C shows elongation at break thereof, and FIG. 12D shows toughness thereof. Also, the mechanical properties as shown in FIGS. 12A, 12B, 12C and 12D are summarized in Table 2 below.

TABLE 2

| | Modulus | Tensile strength | Elongation | Toughness |
|---|---|---|---|---|
| | (MPa) | (MPa) | (%) | (MJ/m³) |
| CSW/HPMC | 13.6 ± 2.8 | 19.8 ± 5.5 | 2.8 ± 1.3 | 52.6 ± 22.3 |
| CSW/HPC | 15.4 ± 3.8 | 10.5 ± 4.1 | 0.8 ± 0.3 | 3.3 ± 1.3 |
| CSW/SA | 16.5 ± 2.7 | 32.9 ± 3.2 | 6.2 ± 1.4 | 141.3 ± 31.3 |
| CSW/CMC | 22.9 ± 4.6 | 36.0 ± 6.0 | 5.0 ± 1.1 | 120.1 ± 38.6 |
| CSW/Xan | 17.8 ± 0.8 | 29.8 ± 1.4 | 3.0 ± 0.7 | 55.8 ± 16.5 |
| CSW/Guar | 26.5 ± 3.5 | 29.1 ± 5.1 | 4.0 ± 0.7 | 83.5 ± 27.8 |

Referring to the results in FIGS. 12A, 12B, 12C, 12D and Table 2, the coating layer manufactured from the coating composition according to Example 5 (SA), which showed a distinct increase in viscosity and uniform spreadability as described above, exhibited excellent modulus, tensile strength, elongation, and toughness in a balanced manner.

### Test Example 8

The three-component coating composition (CSW/SA/BW) according to Example 9 was prepared by adding beeswax (BW) as a natural wax to CSW/SA that showed excellent rheological/mechanical performance as described above.

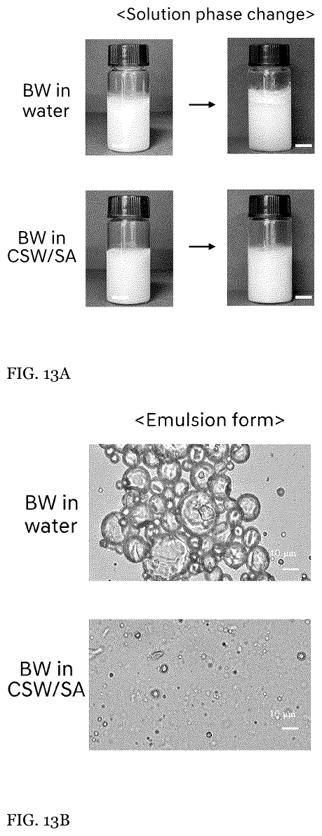

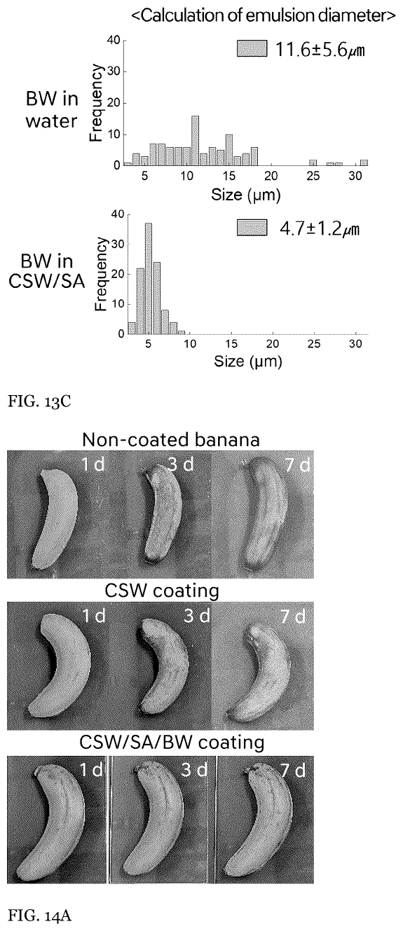

In order to determine a difference between a coating composition prepared by adding only a natural wax (BW) to an aqueous solvent and a Pickering emulsion formed by adding chitosan nanoparticles, a natural binder, and a natural wax, the coating compositions according to Example 9 and Comparative Example 2 were photographed immediately after preparation and after leaving at room temperature for 1 hour, and the results thereof are shown in FIG. 13A. In addition, the coating composition after leaving at room temperature for 1 hour was observed using a TEM, and the results thereof are shown in FIG. 13B. The diameter of the emulsion was calculated from the TEM images, and the results thereof are shown in FIG. 13C.

Referring to FIG. 13A, in the coating composition according to Comparative Example 2 in which only the natural wax (BW) was added to the aqueous solvent, the upper portion thereof was solidified after leaving at room temperature for 1 hour. In contrast, the coating composition according to Example 9 was confirmed to remain emulsified even after leaving at room temperature.

In addition, referring to FIG. 13C, the average particle diameter of the coating composition according to Comparative Example 2 was calculated to be about 11.6 μm, and the average particle diameter of the emulsion in the coating composition according to Example 9 was calculated to be about 4.7 μm, confirming that the average particle diameter of the coating composition according to Comparative Example 2 was about 2.5 times greater than that of Example 9. This is deemed to be because a Pickering emulsion is formed in the coating composition according to Example 9, BW and CSW are present in a core-shell structure (BW core; CSW shell) in the aqueous solvent phase, and the BW particles do not agglomerate with each other but are maintained in a dispersed phase by virtue of the phase stabilization effect due to the viscosity increasing effect of sodium alginate (SA).

### Test Example 9

In order to verify the gas and moisture barrier performance of the coating composition according to the present disclosure, bananas to which the coating composition was not applied and bananas to which the coating compositions according to Comparative Example 1, Example 5, and Example 9 were applied were prepared, after which whether browning occurred over time and how much the weight was reduced due to moisture evaporation were measured.

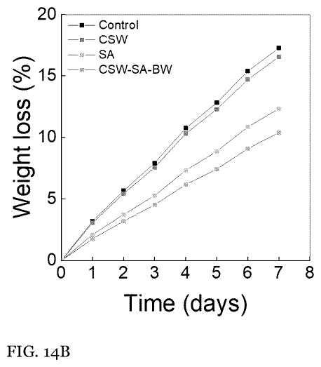

FIG. 14A shows bananas with no coating composition applied and bananas with the coating compositions applied according to Comparative Example 1 and Example 9 observed over time, and FIG. 14B is a graph showing the weight loss over time of bananas with the coating compositions applied according to Comparative Example 1, Example 5, and Example 9. The specific numerical values for the weight loss as shown in FIGS. 14A and 14B are summarized in Table 3 below.

TABLE 3

| Weight loss (%) | 1 day | 2 days | 3 days | 4 days | 5 days | 6 days | 7 days |
|---|---|---|---|---|---|---|---|
| Non-coated | 3.2 | 5.7 | 7.9 | 10.7 | 12.8 | 15.4 | 17.3 |
| CSW | 3.1 | 5.4 | 7.6 | 10.3 | 12.3 | 14.7 | 16.5 |
| CSW/SA | 2.1 | 3.7 | 5.3 | 7.3 | 8.9 | 10.9 | 12.3 |
| CSW/SA/BW | 1.8 | 3.2 | 4.5 | 6.2 | 7.4 | 9.1 | 10.4 |

Referring to FIG. 14A, FIG. 14B and Table 3, bananas coated with the 3-component solution containing CSW/SA/BW showed no apparent browning and the lowest weight loss. Thereby, it was indirectly confirmed that the CSW/SA/BW solution was the most effective in blocking oxygen (gas) coming into contact with bananas.

As is apparent from the foregoing, a coating composition according to the present disclosure can include chitosan nanoparticles derived from biomass and a natural binder, and thus is environmentally friendly and can exhibit improved viscosity and gas barrier properties. In addition, the coating composition according to the present disclosure can further include a natural wax, forming a Pickering emulsion, thus further improving gas barrier properties.

The effects of the present disclosure are not limited to the foregoing. It should be understood that the effects of the present disclosure include all effects that can be inferred from the description of the present disclosure.

As the implementations of the present disclosure have been described above, those skilled in the art will appreciate that various modifications and alterations are possible through change, deletion or addition of components without departing from the scope and spirit of the present disclosure as described in the accompanying claims, which will also be said to be included within the scope of rights of the present disclosure.

What is claimed is:

1. A coating composition for a vehicle, comprising:
an aqueous dispersion comprising chitosan nanoparticles dispersed in an aqueous solvent; and
a natural binder.

2. The coating composition of claim 1, wherein each of the chitosan nanoparticles has any one shape selected from a group consisting of a rod, fibril, filament, whisker, and combinations thereof.

3. The coating composition of claim 1, wherein a diameter of each of the chitosan nanoparticles is greater than or equal to 10 nanometers (nm) and less than or equal to 100 nm, and
wherein a length of each of the chitosan nanoparticles is greater than or equal to 100 nm and less than or equal to 500 nm.

4. The coating composition of claim 1, wherein each of the chitosan nanoparticles is represented by a following Chemical Formula:

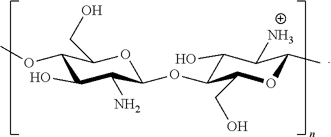

5. The coating composition of claim 1, wherein the natural binder comprises a negatively charged binder.

6. The coating composition of claim 1, wherein the natural binder comprises any one selected from a group consisting of gelatin, hydroxypropyl cellulose (HPC), hydroxypropyl methyl cellulose (HPMC), polyvinyl alcohol (PVA), sodium alginate (SA), xanthan gum, carboxymethyl cellulose (CMC), guar gum, and combinations thereof.

7. The coating composition of claim 1, wherein a weight ratio of the chitosan nanoparticles to the natural binder is from 1:0.1 to 1:3.

8. The coating composition of claim 1, wherein the coating composition has a viscosity of 0.1 Pascal·second (Pa·S) to 40 Pa·S.

9. The coating composition of claim 1, wherein a concentration of the chitosan nanoparticles in the aqueous dispersion is 0.1 weight/weight % (w/w %) to 5 w/w %.

10. The coating composition of claim 1, further comprising a natural wax.

11. The coating composition of claim 10, wherein the natural wax comprises any one selected from a group consisting of beeswax, soy wax, palm wax, rice bran wax, carnauba wax, candelilla wax, shellac wax, and combinations thereof.

12. The coating composition of claim 10, wherein a weight ratio of the chitosan nanoparticles to the natural wax is from 1:0.1 to 1:10.

13. The coating composition of claim 10, wherein the coating composition comprises a core-shell complex having a core,
wherein the core comprises the natural wax and a shell, and
wherein the chitosan nanoparticles are formed around a surface of the core.

14. The coating composition of claim 13, wherein an average particle diameter of the core-shell complex is greater than or equal to 3.5 μm and less than or equal to 6 μm.

15. An article for use with a vehicle, comprising:
a coating layer,
wherein a composition of the coating layer comprises:
chitosan nanoparticles dispersed in, and
a natural binder.

16. The article of claim 15, wherein the coating layer has:
a Young's modulus of 13.5 megapascal (MPa) to 27 MPa,
tensile strength of 10.0 MPa to 37 MPa,
an elongation of 0.5% to 6.5%, and
toughness of 3.0 megajoules per cubic meter (MJ/m³) to 145 MJ/m³.

17. The article of claim 15, wherein each of the chitosan nanoparticles has any one shape selected from a group consisting of a rod, fibril, filament, whisker, and combinations thereof.

18. The article of claim 15, wherein a diameter of each of the chitosan nanoparticles is greater than or equal to 10 nanometer (nm) and less than or equal to 100 nm, and
wherein a length of each of the chitosan nanoparticles is greater than or equal to 100 nm and less than or equal to 500 nm.

19. The article of claim 15, wherein the natural binder comprises a negatively charged binder.

20. The article of claim 15, wherein a weight ratio of the chitosan nanoparticles to the natural binder is from 1:0.1 to 1:3.
